(19) United States
(12) Patent Application Publication
(10) Pub. No.: US 2011/0074540 A1
(43) Pub. Date: Mar. 31, 2011

(54) CONTROL SYSTEM AND METHOD FOR INTERFACE OF ELECTRONIC DEVICE

(75) Inventor: LI-YING CHANG, Taipei Hsien (TW)

(73) Assignee: HON HAI PRECISION INDUSTRY CO., LTD., Taipei Hsien (TW)

(21) Appl. No.: 12/608,951

(22) Filed: Oct. 29, 2009

(30) Foreign Application Priority Data
Sep. 29, 2009 (CN) 200910307967.3

(51) Int. Cl. G06F 7/04; G06K 9/46

(52) U.S. Cl. 340/5.8; 382/190

(57) ABSTRACT

A control system for controlling interfaces of an electronic device. The electronic device includes a display device. The control system includes a storage module stores a plurality of human face images and desktop media files. A detecting module detects whether a face of a user is within a determined range and accordingly outputs a detection signal in response to the face being within the determined range. An image capture module captures a face image of the user according to the detection signal and outputs the face image. An identify module receives the face image and compares the face image with the plurality of stored human face images in the storage module, for identifying the age of the user, and output an identification result. A control module reads a corresponding desktop media file from the storage module according to the identification result and displays the media file on the display device.

### BACKGROUND

1. Technical Field

The present disclosure relates to a control system and a control method for interfaces of an electronic device.

2. Description of Related Art

At present, a desktop picture of an electronic device, such as a computer, is fixed until a user inputs instructions to change it, which is inconvenient.

### BRIEF DESCRIPTION OF THE DRAWINGS

FIG. 1 is a block diagram of an embodiment of a control system for interfaces of an electronic device.

FIGS. 2A-2B are flowcharts of an embodiment of a control method for interfaces of an electronic device.

### DETAILED DESCRIPTION

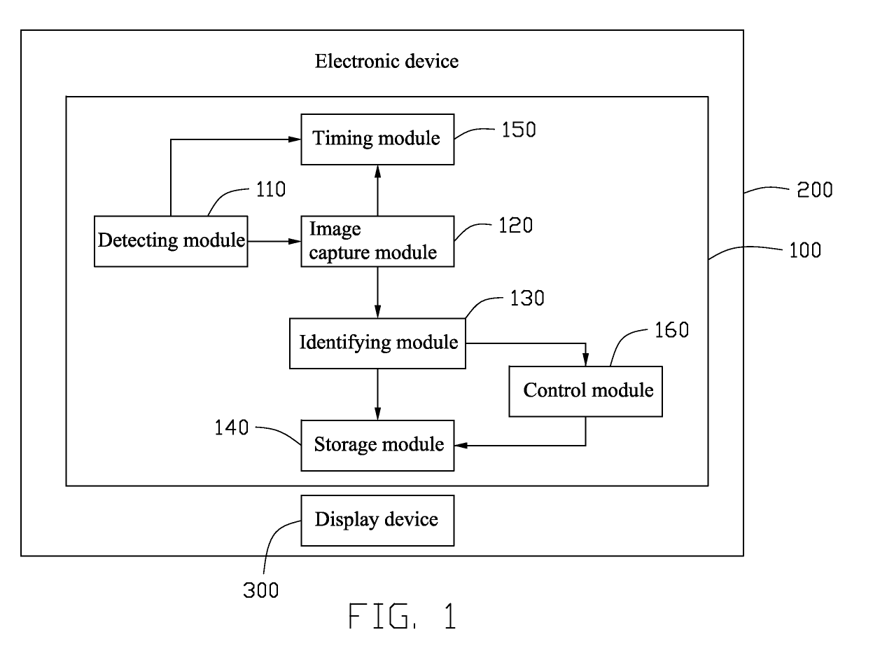

Referring to FIG. 1, a control system 100 for controlling interfaces of an electronic device 200, such as a computer, is disclosed. The electronic device 200 includes a display device 300. An exemplary embodiment of the control system 100 includes a detecting module 110, an image capture module 120, an identifying module 130, a storage module 140, a timing module 150, and a control module 160. In one embodiment, the detecting module 110 is an infrared face detecting apparatus. The image capture module 120 is a camera.

The timing module 150 records time according to a timing signal. The storage module 140 stores human face images, facial expression images, desktop pictures, and special media files. The special media files may include, for example, image files, music files etc. The detecting module 110 detects whether a face of a user is within a determined range. If the face of the user is not within the determined range, the detecting module 110 outputs a first timing signal to the timing module 150 for recording the time. When time of the first timing signal reaches a preset time, the detecting module 110 further detects whether the face of the user is within the determined range. If the face of the user is now within the determined range, the detecting module 110 outputs an image signal to the image capture module 120 for capturing a face image of the user, and sends the face image to the identifying module 130. The identifying module 130 compares the received face image of the user with the stored human face images in the storage module 140, to identify the age of the user, and outputs an identifying result to the control module 160. The control module 160 reads a corresponding desktop picture from the storage module 140 according to the identify result to be displayed on the display device 300.

The image capture module 120 also captures an expression image of the user and sends the expression image to the identifying module 130, and outputs a second timing signal to the timing module 150 for recording time. The identifying module 130 compares the received expression image of the user with the stored facial expression image in the storage module 140, to identify the expression of the user, and outputs a control signal to the control module 160, to read a corresponding special media file from the storage module 140. When time of the second timing signal reaches a preset time, the control module 160 stops execution of the special media file. If the detecting module 110 detects the face of the user is still within the determined range, the image capture module 120 captures an expression image of the user again and sends the expression image to the identifying module 130. The control module 160 reads a corresponding special media file from the storage module 140 according to the expression image of the user.

In use, when the detecting module 110 detects the face of the user is within the determined range, the identifying module 130 compares the received face image from the image capture module 120 with the stored human face images in the storage module 140. If the user is, for example, a child, the control module 160 reads a desktop picture for children, such as a desktop picture of a cartoon character, from the storage module 140 to be displayed on the display device 300. If the user is old, such as a senior citizen, the control module 160 reads a desktop picture for seniors, such as a simple form and character magnified desktop picture, from the storage module 140 to be displayed on the display device 300. At the same time, the image capture module 120 captures the expression image of the user and sends the expression image to the identifying module 130, and outputs the second timing signal to the timing module 150 for recording time. When the expression of the user is depressed, the control module 160 reads a special media file from the storage module 140, for example, play soft music to relax the user. When time of the second timing signal reaches a preset time, the control module 160 stops playing the music. If the face of the user is still within the determined range, the image capture module 130 captures an expression image of the user again and sends the expression image to the identifying module 130. When the expression of the user is, for example, glad, the control module 160 reads a special media file from the storage module 140, for example, a favorite pet performing a trick to keep the user glad.

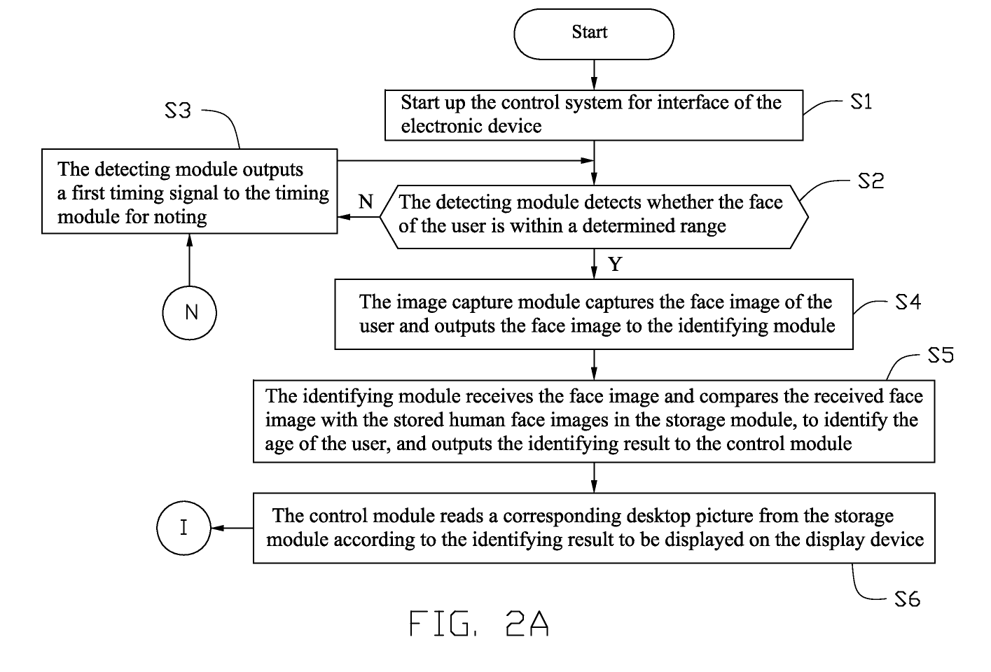

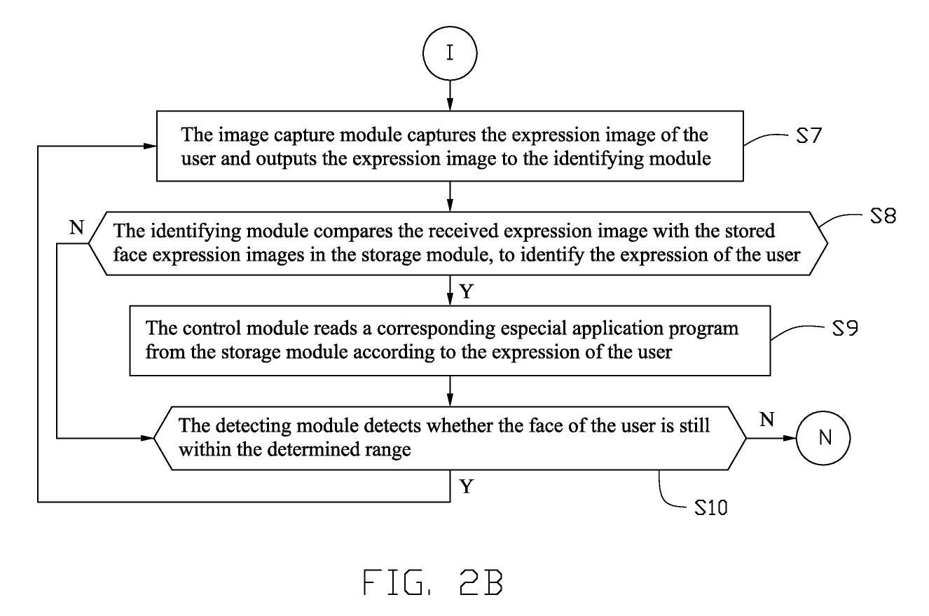

Referring to FIGS. 2A and 2B, an exemplary embodiment of a control method for interfaces of an electronic device includes the following steps.

In step S1, start up the control system 100 for interfaces of the electronic device.

In step S2, the detecting module 110 detects whether the face of the user is within a determined range, if the face of the user is not within the determined range, the procedure goes to step S3, if the face of the user is within the determined range, the procedure goes to step S4.

In step S3, the detecting module 110 outputs a first timing signal to the timing module 150 for recording time, when time of the first timing signal reaches a preset time, the procedure goes to step S2.

In step S4, the image capture module 120 captures a face image of the user and outputs the face image to the identifying module 130.

In step S5, the identifying module 130 compares the received face image with the stored human face images in the storage module 140, to identify the age of the user, and outputs an identifying result to the control module 160.

In step S6, the control module 160 reads a corresponding desktop picture from the storage module 140 according to the identifying result to be displayed on the display device 300.

In step S7, the image capture module 120 captures an expression image of the user and outputs the expression image to the identifying module 130, and outputs a second timing signal to the timing module 150 for recording time.

In step S8, the identifying module 130 compares the received expression image with the stored facial expression images in the storage module 140, to identify the expression of the user.

In step S9, the control module 160 reads and displays a corresponding special media file from the storage module 140 according to the expression of the user.

In step S10, the detecting module 110 detects whether the face of the user is still within the determined range, if the face of the user is still within the determined range, the procedure goes back to step S7, if the face of the user is not within the determined range, the procedure goes back to step S3.

The control system 100 can identify the age of the user and display a corresponding desktop picture on the display device 300 according to the age of the user through the identifying module 130. The identifying module 130 outputs a control signal to the control module 160, to read a corresponding special media file according to the facial expression of the user from the image capture module 120. The control system 100 can automatically replace desktop pictures according to different users.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A control system for controlling interfaces of an electronic device, the electronic device comprising a display device, the control system comprising:
a storage module to store a plurality of human face images and a plurality of desktop media files;
a detecting module to detect whether a face of a user is within a determined range and accordingly outputs a detection signal in response to the face being within the determined range;
an image capture module to capture a face image of the user according to the detection signal and outputs the face image;
an identify module to receive the face image and compare the face image with the plurality of stored human face images in the storage module, for identifying the age of the user, and output an identification result; and
a control module to read a corresponding desktop media file from the storage module according to the identification result and display the media file on the display device.

2. The control system of claim 1, wherein the plurality of human face images comprises a plurality of facial expression images, and the plurality of the desktop media files comprises a plurality of special media files, the image capture module captures an expression image of the user and sends the expression image to the identifying module, the identifying module receives the expression image of the user and compares the received expression image with the plurality of stored facial expression images in the storage module, to identify the expression of the user, and outputs a control signal to the control module, to read a corresponding special media file from the storage module.

3. The control system of claim 1, further comprising a timing module to record time, wherein when the detecting module detects the face of the user of the electronic device is not within the determined range, the image capture module outputs a first timing signal to the timing module for recording time, and when time of the first timing signal reaches a preset timing time, the detecting module detects again whether the face of the user is within the determined range.

4. The control system of claim 3, wherein the plurality of human face images comprises a plurality of facial expression images, and the plurality of the desktop media files comprises a plurality of special media files, the image capture module captures an expression image of the user in response to the face of the user being within the determined range, and outputs a second timing signal to the timing module for recording time, when time of the second timing signal reaches a preset time, the image capture module captures a new expression image of the user and sends the new expression image to the identifying module in response to the face of the user being still within the determined range, to identify the expression of the user by the identifying module comparing the new expression image with the plurality of facial expression images, the control module reads a corresponding special media file from the storage module according to a comparison result between the new expression image and the plurality of facial expression images.

5. The control system of claim 4, wherein the plurality of special media files comprise cartoon programs.

6. The control system of claim 1, wherein the detecting module is an infrared face detecting apparatus.

7. The control system of claim 1, wherein the image capture module is a camera.

8. A control method for controlling an interface of an electronic device, the control method comprising:
detecting whether a face of a user is within a determined range;
capturing the face image of the user, in response to the face of the user being within the determined range;
comparing the captured face image with a plurality of stored human face images, to identify the age of the user; and
reading a corresponding desktop media file and displaying the media file on the display device, according to the age of the user.

9. The control method of claim 8, further comprising outputting a timing signal to a timing module for recording time in response to the face of the user not being within the predetermined range, wherein when time of the first timing signal reaches a preset time, continuing detecting whether the face of the user is within the determined range.

10. The control method of claim 8, further comprising:
capturing an expression image of the face of the user in response to the face of the user being within the predetermined range;
comparing the received expression image with a plurality of stored facial expression images, to identify the expression of the user; and
reading a corresponding special media file according to the expression of the user.
